(19) United States
(12) Patent Application Publication
(10) Pub. No.: US 2020/0086933 A1
(43) Pub. Date: Mar. 19, 2020

(54) BUMPER BASED TIRE CARRIER

(71) Applicants: Lacey Steen, Lewistown, MT (US); Jim Steen, Lewistown, MT (US)

(72) Inventors: Lacey Steen, Lewistown, MT (US); Jim Steen, Lewistown, MT (US)

(21) Appl. No.: 16/576,282

(22) Filed: Sep. 19, 2019

Related U.S. Application Data
(63) Continuation of application No. 62/731,153, filed on Sep. 14, 2018.

(51) Int. Cl. B62D 43/04; B60R 19/18

(52) U.S. Cl. CPC B62D 43/04; B60R 2019/1813; B60R 19/18

(57) ABSTRACT

A bumper based tire carrier supports a tire and wheel set. The bumper based tire carrier includes a vehicle bumper that is bolted onto a frame of a vehicle. The vehicle bumper includes a hinge. A single bolt slot is incorporated into the hinge. A tire carrier frame is connected to the hinge with a single bolt inserted through the single bolt slot and an end joint of the tire carrier frame. A tire adapter is also connected to the tire carrier frame. The tire adapter is attached to support the tire and wheel set. Furthermore, a locking mechanism is integrated to the vehicle bumper. The locking mechanism fastens the tire carrier frame to the vehicle bumper.

### CLAIM OF PRIORITY

This application is a United States utility application having priority to U.S. provisional application Ser. No. 62/731,153, filed Sep. 14, 2018 entitled “Bumper Based Tier Carrier”, the entirety of which is hereby incorporated by reference as if fully set forth herein.

### FIELD OF THE EMBODIMENTS

The field of the present invention and its embodiments relate to a bumper based tire carrier that supports a tire and wheel set and can act as a utility platform.

### BACKGROUND OF THE EMBODIMENTS

Transportation is an integral part of daily life. Personal and public vehicles significantly impact daily life by increasing access to resources available to individuals. For example, vehicular transportation enables a person to work and live in different communities separated by a significant distance. Some forms of transportation also serve multiple purposes. For example, trucks and sport utility vehicles (SUV) enable an individual to transport variety of items of significant size and weight in addition to providing transportation for the individual and others. Trucks and SUVs provide diverse utilization scenarios because of parts that ease access to or improve utility of the vehicles. Bumpers on utility vehicles are parts that provide vehicle protection and support other use case scenarios.

Examples of use case scenarios associated with bumpers on utility vehicles are provided below.

For instance, U.S. Pat. No. 4,993,610 pertains to heavy duty protective apparatus mounted at the rear of a vehicle, that includes metal containers extending laterally from the vehicle to serve as a bumper, the containers form interior spaces to receive and transport equipment such as tools.

U.S. Pat. No. 7,293,681 B2 pertains to a rack designed to provide convenient storage of doors optionally removable from an SUV. This allows a driver to operate the vehicle with the doors removed and therefore free up interior space. The rack is mounted on the rear of the vehicle exteriorly of the rear mounted spare tire.

U.S. Pat. No. 8,528,800 B1 pertains to a vehicle that includes a vehicle bumper attached to a vehicle frame. A tire carrier support structure is attached to the vehicle frame, where the vehicle bumper and tire carrier support structure are held together by a D-ring assembly. A tire carrier assembly has a tire carrier arm moveable between stowed and deployed positions, and raised and lowered positions, is carried by the tire carrier support structure.

US 2011/0101049 A1 pertains to a bumper-equipped spare-tire carrier to be mounted on the rear bumper of an automobile, the bumper provides carry-space for the spare tire in an elegant and stylish manner, and may be moved forward and back by remote control, appealing strongly to low-rider and other auto enthusiasts.

Various systems and methodologies are known in the art. However, their structure and means of operation are substantially different from the present disclosure. The other inventions fail to solve all the problems taught by the present disclosure. At least one embodiment of this invention is presented in the drawings below and will be described in more detail herein.

### SUMMARY OF THE EMBODIMENTS

The present invention and its embodiments relate to a bumper based tire carrier. In an example embodiment of the present invention, the bumper based tire carrier may include a vehicle bumper. The vehicle bumper may be bolted onto a frame of a vehicle. The tire carrier may also include a hinge connected to the vehicle bumper. The hinge may include a single bolt slot. An end joint of the tire carrier frame may be connected to the hinge with a single bolt. A tire adapter may also be connected to the tire carrier frame. The tire adapter may support a tire and wheel set. Furthermore, a locking mechanism may be connected to the vehicle bumper. The locking mechanism may fasten the tire carrier frame to the vehicle bumper.

In another embodiment of the present invention, a bumper based tire carrier system is described. The system may include a vehicle bumper. The vehicle bumper may be bolted onto a frame of a vehicle. Right and left hinges may be connected to the vehicle bumper. The right and left hinges may each include a single bolt slot. A left end joint of a left tire carrier frame may be connected to the left hinge with a single bolt. A right end joint of a right tire carrier frame may be connected to the right hinge with a single bolt. A tire adapter may also be connected to the left or right carrier frames. The tire adapter may support a tire and wheel set. Furthermore, right and left locking mechanisms may be connected to the vehicle bumper. The left locking mechanism may fasten the left tire carrier to the vehicle bumper. The right locking mechanism may fasten the right tire carrier to the vehicle bumper.

In yet another embodiment of the present invention, a method of providing a bumper based tire carrier is described. In an example scenario, a vehicle bumper may be bolted onto a frame of a vehicle. A tire carrier frame may be connected to a hinge integrated to the vehicle bumper. A single bolt may be used to connect an end joint of the tire carrier frame to the hinge. A tire adapter may be attached to the tire carrier frame. The tire carrier frame adapter may support a tire and wheel set. The tire and wheel set may be mounted to the tire adapter. Furthermore, the tire carrier frame may be fastened to the vehicle bumper with a locking mechanism.

It is an object of the present invention to provide a bumper based tire carrier.

It is an object of the present invention to provide a tire carrier frame constructed with a tubular structure for a high strength to weight use scenario.

It is an object of the present invention to connect the tire carrier frame to the vehicle bumper with a hinge and single bolt that provides 180 degree motion or more.

It is an object of the present invention to secure the tire carrier frame to the vehicle bumper with a locking mechanism.

It is an object of the present invention to mount a tire and wheel set on the tire carrier frame using an attached tire adapter.

### BRIEF DESCRIPTION OF THE DRAWINGS

FIG. 1A shows a component view of an embodiment of the present invention.

FIG. 1B shows an operational view of an embodiment of the present invention.

FIG. 2 shows a detailed view of a hinge associated with the present invention.

FIG. 3 shows an operational view of a mounted tire jack associated with the present invention.

### DESCRIPTION OF THE PREFERRED EMBODIMENTS

The preferred embodiments of the present invention will now be described with reference to the drawings. Identical elements in the various figures are identified with the same reference numerals.

Reference will now be made in detail to each embodiment of the present invention. Such embodiments are provided by way of explanation of the present invention, which is not intended to be limited thereto. In fact, those of ordinary skill in the art may appreciate upon reading the present specification and viewing the present drawings that various modifications and variations can be made thereto.

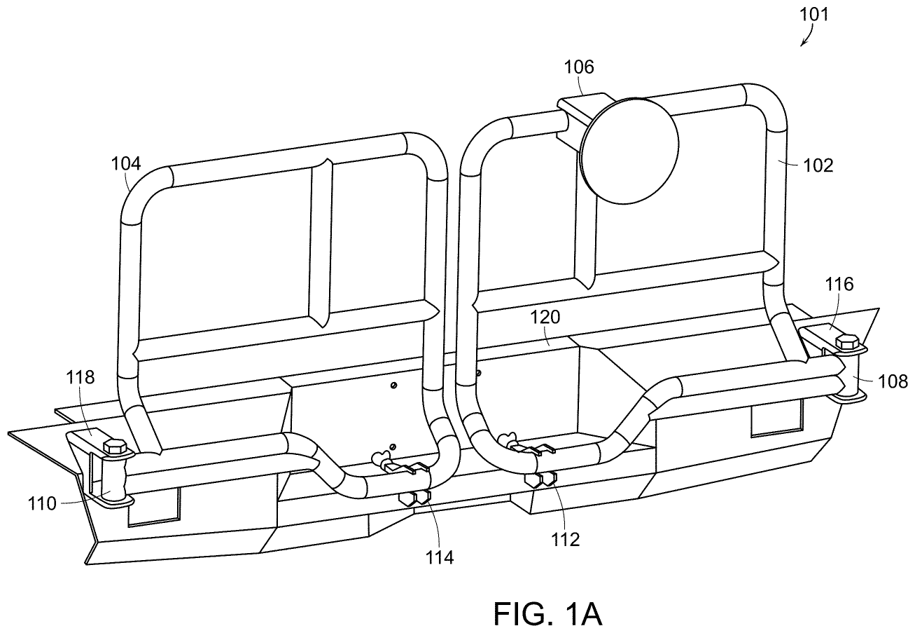

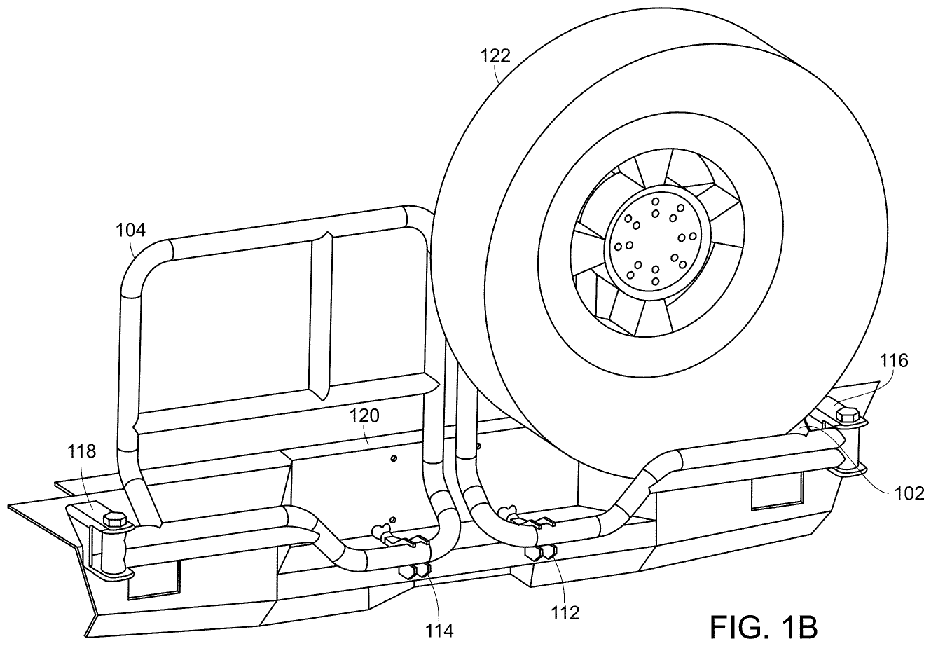

FIG. 1A shows a bumper based tire carrier 101. The bumper based tire carrier 101 may include a vehicle bumper 120, a right tire carrier frame 102, a left tire carrier frame 104, and other supporting components. The vehicle bumper 120 may be bolted to a frame of a vehicle such as a truck, and/or a sport utility vehicle, among others. Alternatively, the vehicle bumper 120 may be fastened to the vehicle frame with connecting components such as bolts, screws, joints, and/or adapters, among others. In yet another alternative scenario, the vehicle bumper 120 may be bolted or otherwise fastened on to an existing vehicle bumper without damaging and/or destroying functionality associated with the existing vehicle bumper.

The right and left tire carrier frames (102 and 104) may be constructed with tube based structures to achieve a high strength to weight ratio use scenario. The right and left tire carrier frames (102 and 104) may be composed of a metal based material, and/or a composite based material, among others. The right and left tire carrier frames may be attached to the vehicle bumper 120 through right and left hinges (116 and 118), respectively. The right and left hinges (116 and 118) may be structures of the vehicle bumper 120. Alternatively, the right and left hinges (116 and 118) may be attachable components that may be connected to the vehicle bumper 120 by bolting and/or fastening, among other mechanisms.

Each of the right and left hinges (116 and 118) may include a single bolt slot for connecting the right and left tire carrier frames (102 and 104) to the associated hinges (116 and 118). End joints (108 and 110) of the of the right and left tire carrier frames (102 and 104) may also include the single bolt slot. The single bolt slots may include a circumference that accommodates a single bolt. To connect the right tire carrier frame 102 to the vehicle bumper 120, the end joint 108 of the right tire carrier frame 102 may be inserted into the right hinge 116. The end joint 108 may be secured to the right hinge 116 with the single bolt inserted through the single bolt slots on the right hinge 116 and the end joint 108. To connect the left tire carrier frame 104 to the vehicle bumper 120, the end joint 110 of the left tire carrier frame 104 may be inserted into the left hinge 118. The end joint 110 may be secured to the left hinge 118 with another single bolt inserted through the single bolt slots on the left hinge 118 and the end joint 110. Removal of either or both of the right and left tire carrier frames (102 and/or 104) may be accomplished by executing previous steps in reverse.

The right and left tire carrier frames (102 and 104) may be secured to the vehicle bumper 120 through right and left locking mechanisms (112 and 114). The right and left locking mechanisms (112 and 114) may be integrated to the vehicle bumper 120. The right locking mechanism 112 may be used to fasten the right tire carrier frame 102 to the vehicle bumper 120. The left locking mechanism 114 may be used to fasten the left tire carrier frame 104 to the vehicle bumper 120. A Utility platform can be attached to either the right or left side of the bumper, or both. A tire and wheel set or any other utilitarian need may be attached to either platform.

FIG. 1B shows a tire and wheel set 122 mounted to the right tire carrier frame 102. The tire and wheel set 122 may be mounted onto the tire adapter connected to the right tire carrier frame 102. The tire adapter may be detachable. Different tire adapters may be used based on a type of the tire and wheel set 122. For example, a standard tire adapter may be attached to the right tire carrier frame 102 for a spare tire. An alternative tire adapter may be attached to the right tire carrier frame 102 for a specialized tire and wheel set such as an off road tire and wheel set.

A universal tire adapter may also be connected to the right tire carrier frame 102 to mount a variety of tire and wheel types such as the tire and wheel set 122. Alternatively, the universal tire adapter may be connected to the left tire carrier frame 104. The right and left tire carrier frames (102 and 104) may each have an attached tire adapter. Furthermore, the tire adapter may be connected to both the right and left tire carrier frames (102 and 104) through joints attached to the right and left tire carrier frames (102 and 104). The tire adapter attached to both the right and left tire carrier frames (102 and 104) may be capable of carrying additional weight because of support provided by multiple joints connecting the tire adapter.

The right and left tire carrier frames (102 and 104) may be fastened to the vehicle bumper 120 through the right and left locking mechanisms (112 and 114), respectively. A user may unlatch the right and/or left locking mechanisms (112 and/or 114) to release the right and/or left tire carrier frames (102 and/or 104). The user may be able to swing the right and/or left tire carrier frames (102 and/or 104) up to a 180 degrees from a latched position associated with the right and/or left locking mechanisms (112 and/or 114). The swing action may be centered around the right hinge 116 for the right tire carrier frame 102. The swing action may be centered around the left hinge 118 for the left tire carrier frame 104. The right and /or left tire carrier frames (102 and/or 104) may also swing further than 180 degrees from the latched position. The maximum angle for the swing action may be constricted by external body of the vehicle and the positioning of the right and/or left hinges (116 and/or 118) in relation to the vehicle bumper 120.

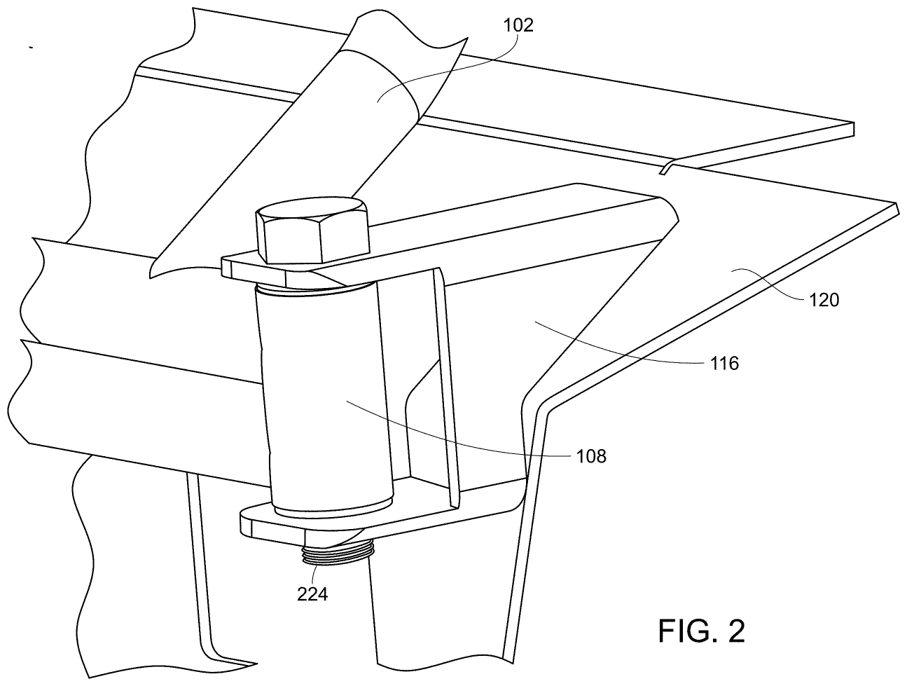

FIG. 2 shows a detailed view of the right hinge 116. The right hinge 116 (or the left hinge) may be a component of the vehicle bumper 120. The vehicle bumper 120 may be constructed from a material capable of withstanding a weight of the right tire carrier frame 102, the tire adapter, the tire and wheel set, and/or other items attached to the right tire carrier frame 102. As such, the right hinge 116 may support the weight of attached items through stresses subjected during a variety of use scenarios such as off road usage, and/or high speed cornering, among others, without failure.

A bolt 224 may connect the end joint 108 of the right tire carrier frame 102 to the right hinge 116. The end joint 108 may be secured to the right hinge 116 with a threaded bolt that fastens to a treaded slot at a bottom section of the right hinge 116. Alternatively, a slide on bolt may be used to secure the end joint 108 to the right hinge 116. In such a scenario, a locking mechanism such as a locking nut may be used to secure the slide on bolt in between the end joint 108 and the right hinge 116.

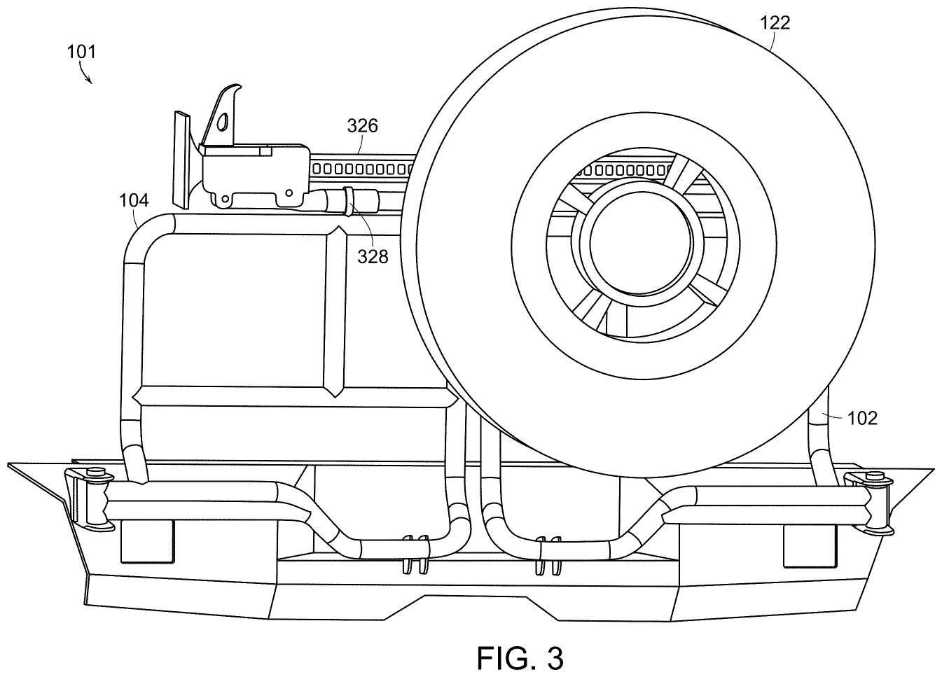

FIG. 3 shows the bumper based tire carrier 101 with an attached universal compression device 326. An example of the universal compression device 326 may include a tire jack. The universal compression device 326 may be attached to the left tire carrier frame 104 with a universal compression adapter 328. The universal compression adapter 328 may be connected to a top section of the left tire carrier frame 104. Alternatively, the universal compression device 326 may be attached to a top section of the right tire carrier frame 102 through the universal compression adapter 328 connected to the top section. In another scenario, the universal compression device 326 may be attached to a side section of the right or left tire carrier frames (102 or 104) through the universal compression adapter 328 connected to the side section. Additional universal compression adapters may be used to secure the universal compression device 326 to the right or left tire carrier frames (102 and/or 104) to provide additional support to carry the universal compression adapter 326 that has a heavier weight.

Furthermore, the universal compression adapter 328 connected to the right or left tire carrier frames (102 or 104) may be used to attach a storage item to the right or left tire carrier frames (102 or 104). Additional universal compression adapter(s) may be used to attach other storage items to the right and/or left tire carrier frames (102 and/or 104) or a single storage item to both the right and left tire carrier frames (102 and 104) to support a heavier weight associated with the single storage item. An example of the storage item may include a water container, a fuel container, and/or a power generator, among others.

A method of providing a bumper based tire carrier is also described. In an example scenario, a vehicle bumper may be bolted onto a frame of a vehicle. A tire carrier frame may be connected to a hinge integrated to the vehicle bumper. A single bolt may be used to connect an end joint of the tire carrier frame to the hinge. A tire adapter may be attached to the tire carrier frame. The tire carrier frame adapter may support a tire and wheel set. The tire and wheel set may be mounted to the tire adapter. Furthermore, the tire carrier frame may be secured to the vehicle bumper by fastening the tire carrier frame to the vehicle bumper with a locking mechanism.

Although this invention has been described with a certain degree of particularity, it is to be understood that the present disclosure has been made only by way of illustration and that numerous changes in the details of construction and arrangement of parts may be resorted to without departing from the spirit and the scope of the invention.

What is claimed is:

1. A bumper based tire carrier apparatus comprising:
a vehicle bumper, wherein the vehicle bumper is configured to be bolted onto a frame of a vehicle;
a hinge coupled to the vehicle bumper, wherein the hinge includes a single bolt slot;
a tire carrier frame connected to the hinge with a single bolt, wherein the single bolt is configured to connect the hinge with an end joint of the tire carrier frame;
a tire adapter coupled to the tire carrier frame, wherein the tire adapter is configured to support a tire and wheel set; and
a locking mechanism coupled to the vehicle bumper, wherein the locking mechanism is configured to fasten the tire carrier frame to the vehicle bumper.

2. The bumper based tire carrier apparatus of claim 1, further comprising:
an additional hinge coupled to the vehicle bumper, wherein the additional hinge includes a single bolt slot;
an additional tire carrier frame connected to the additional hinge with a single bolt, wherein the single bolt is configured to connect the additional hinge with an end joint of the second tire carrier;
an additional tire adapter coupled to the additional tire carrier frame, wherein the additional tire adapter is configured to support an additional tire and wheel set; and
an additional locking mechanism coupled to the vehicle bumper, wherein the additional locking mechanism is configured to secure the additional tire carrier frame to the vehicle bumper.

3. The bumper based tire carrier apparatus of claim 1, wherein the tire carrier frame is composed of tube based structures.

4. The bumper based tire carrier apparatus of claim 1, wherein the tire carrier frame is composed of a metal based material.

5. The bumper based tire carrier apparatus of claim 1, wherein the tire carrier frame is composed of a composite based material.

6. The bumper based tire carrier apparatus of claim 1, wherein the single bolt is a threaded bolt.

7. The bumper based tire carrier apparatus of claim 1, wherein the single bolt is an unthreaded bolt.

8. The bumper based tire carrier apparatus of claim 7, wherein the unthreaded bolt is securable with a lock nut.

9. The bumper based tire carrier apparatus of claim 1, wherein the tire carrier frame is configured to swing up to a 180 degree angle centered on the hinge from a secured position being fastened to the locking mechanism.

10. The bumper based tire carrier apparatus of claim 1, wherein the tire adapter is configured to be connected to one or more placements on the tire carrier frame.

11. The bumper based tire carrier apparatus of claim 1, wherein the tire adapter is replaceable with another tire adapter being matched to a type of the tire and wheel set to be mounted.

12. A bumper based tire carrier system comprising:
a vehicle bumper, wherein the vehicle bumper is configured to be bolted onto a frame of a vehicle;
right and left hinges coupled to the vehicle bumper, wherein the right and left hinges each include a single bolt slot;
a right tire carrier frame connected to the right hinge, wherein and a right single bolt is configured to connect the right hinge to a right end joint of the right carrier frame;
a left tire carrier frame connected to the left hinge, wherein a left single bolt is configured to connect the left hinge to a left end joint of the left carrier frame;
a tire adapter configured to couple to the left or right tire carrier frames, wherein the tire adapter is configured to support a tire and wheel set; and
right and left locking mechanisms coupled to the vehicle bumper, wherein the left locking mechanism is configured to fasten the left tire carrier frame to the vehicle bumper and the right locking mechanism is configured to fasten the right tire carrier frame to the vehicle bumper.

13. The system of claim 12, further comprising:
a universal compression adapter coupled to a top section of the right tire carrier frame, wherein the universal compression adapter is configured to secure a universal compression device in a position above the right tire carrier frame.

14. The system of claim 12, further comprising:
a universal compression adapter coupled to a top section of the left tire carrier frame, wherein the universal compression adapter is configured to secure a universal compression device in a position above the left tire carrier frame.

15. The system of claim 12, further comprising:
a universal compression adapter coupled to the left or right tire carrier frames, wherein the universal compression adapter is configured to connect a storage item to the left or right tire carrier frames, and wherein the storage item includes a water container, a fuel container, or a power generator.

16. A method of providing a bumper based tire carrier apparatus, the method comprising:
bolting a vehicle bumper onto a frame of a vehicle;
connecting a tire carrier frame to a hinge coupled to the vehicle bumper, wherein a single bolt is used to connect an end joint of the tire carrier frame to the hinge;
attaching a tire adapter to the tire carrier frame, wherein the tire adapter is configured to support a tire and wheel set;
mounting the tire and wheel set to the tire adapter; and
fastening the tire carrier frame to the vehicle bumper with a locking mechanism.
